(19) United States
(12) Patent Application Publication
(10) Pub. No.: US 2002/0042715 A1
(43) Pub. Date: Apr. 11, 2002

(54) Mobile call detail record separation for billing purposes

(76) Inventor: Robert Richard Kelley, Tokyo (JP)

Correspondence Address: Joseph E. Kovarik, Esq., SHERIDAN ROSS P.C., Suite 1200, 1560 Broadway, Denver, CO, 80202-5141, US

(21) Appl. No.: 09/895,017

(22) Filed: Jun. 28, 2001

Related U.S. Application Data
(60) Provisional application No. 60/214,868, filed on Jun. 28, 2000.

(51) Int. Cl. G06F 17/60

(52) U.S. Cl. 705/1

(57) ABSTRACT

A method and system provides employers with the ability to delineate responsibility for payment of billings due to use of communication devices, including mobile calls over communication devices and internet communications, such that the employer can readily determine which particular communication charges the employer is responsible for and what charges an employee should be personally responsible for.

### FIELD OF THE INVENTION

The present invention is directed to a method and system for facilitating the separation of mobile calls into distinct groups, and in particular, separating charges for employees' private, non-work related communications from employer related communications so as to differentiate and bill the appropriate individuals for use of the mobile phone service.

### BACKGROUND OF THE INVENTION

Telecommunications generally represent the second or third largest monthly expense for a company. Telephone calls typically account for more than 75% of this amount. For many companies, it is essential to implement a control system to capture and provide access to the information regarding the usage of a company's telephone or mobile phone usage. Call detail records are the basis of call accounting. Call accounting is the process of collecting, analyzing and reporting call record information. Many companies provide employees with mobile communication devices, such as mobile phones, to facilitate communication with and between vendors, customers and employees. As company-provided devices, the operating costs, both fixed and variable, are initially paid for by the employer. Such devices are, however, also invariably used for the employee's personal communication needs. It is in the interest of the employer to provide the convenience of the use of these devices to its employees, but ideally while minimizing or avoiding incremental costs associated with the use of the mobile phones for purposes other than work-related.

U.S. Pat. Nos. 5,577,100 and 6,198,915 issued to McGregor attempt to provide a mobile phone system which has internal accounting capabilities for real time call debiting to account. The phone system, however, require the use of a dedicated computer, a specially adapted mobile phone, a tracking unit that is a direct couple, interlink receiver, and satellite processors for activating and programming phone units. The complex billing algorithm calculates the call charges as the calls are made for basic categories of local calls, long distance calls, international calls and roaming calls. This system, however, requires the purchase of an entire new system. For those companies who have already committed to mobile phone plans and the hardware associated therewith, a re-investment of capital in order to purchase the McGregor patented system is not feasible.

There is a therefore a long-felt, but unsolved need for employers to have a method and system by which employee content calls made on employer-paid systems can be differentiated such that billings can be generated to properly route charges to the employer, or alternatively, to the employee, as desired.

There is also a long-felt need for a billing method and system that does not require the purchase of an entirely new system but can be adapted for use with mobile phone units already purchased.

### SUMMARY OF THE INVENTION

As used herein, “mobile communication devices” can be cell (mobile) phones, personal digital assistants (such as electronic organizers), car navigation systems, walkie talkies, hand held and/or portable internet communicators, etc. The administrative costs associated with manually separating call detail records relating to such devices between personal and business use are enormous and thus such a practice is usually not practical or cost effective. The present invention provides customized, automated separation of these call detail records for purposes of separated billing. In one embodiment of the present invention, call detail records are generated, typically from a responsible telephone system provider from whom the company has purchased a calling plan and phones. Separate rules dictated by an employer are implemented to evaluate each individual call detail record to determine whether a particular call was made in a business related capacity by an individual or whether such communication can be properly characterized as a personal call. In one particular embodiment, three distinct categories may be defined by such separation rules: i.e., all calls being employer related calls; all calls being employee related calls; and calls that could be considered a mixture of employee personal calls and employer related calls. A billing process implemented as one aspect of the present invention consolidates the call detail records produced pursuant to the above-described separation process into separate statements for the employer and for the employee.

With respect to the separation rules that may be employed by an employer, various distinct programs can be implemented, as described in more detail below in the detailed description of the invention. In brief, however, one or more of the defined methods of separation can be implemented at the option of an employer in an effort to reasonably allocate charges to be properly paid for by an employer and/or alternatively by an employee.

Other embodiments and aspects of the present invention will be revealed by a review of the drawings and the detailed description of the present invention.

### BRIEF DESCRIPTION OF THE DRAWINGS

FIG. 1 illustrates a statement generation process of the present invention.

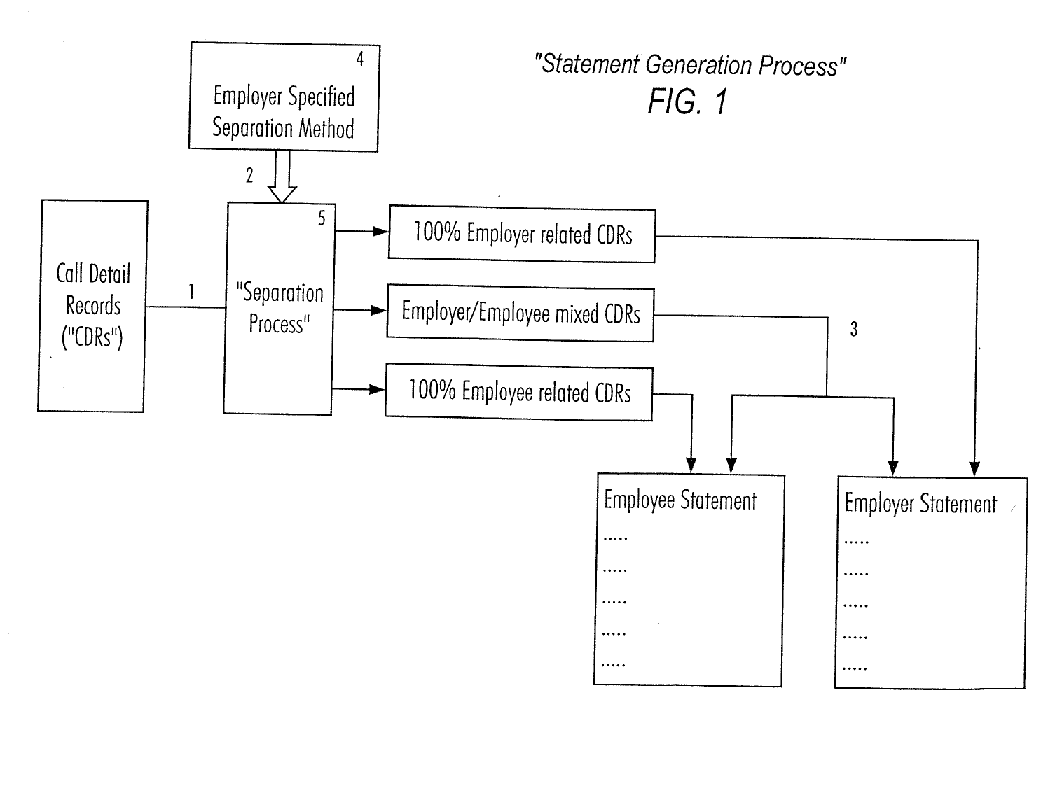

FIG. 2 illustrates a flow diagram of the steps of the method employed by the present invention.

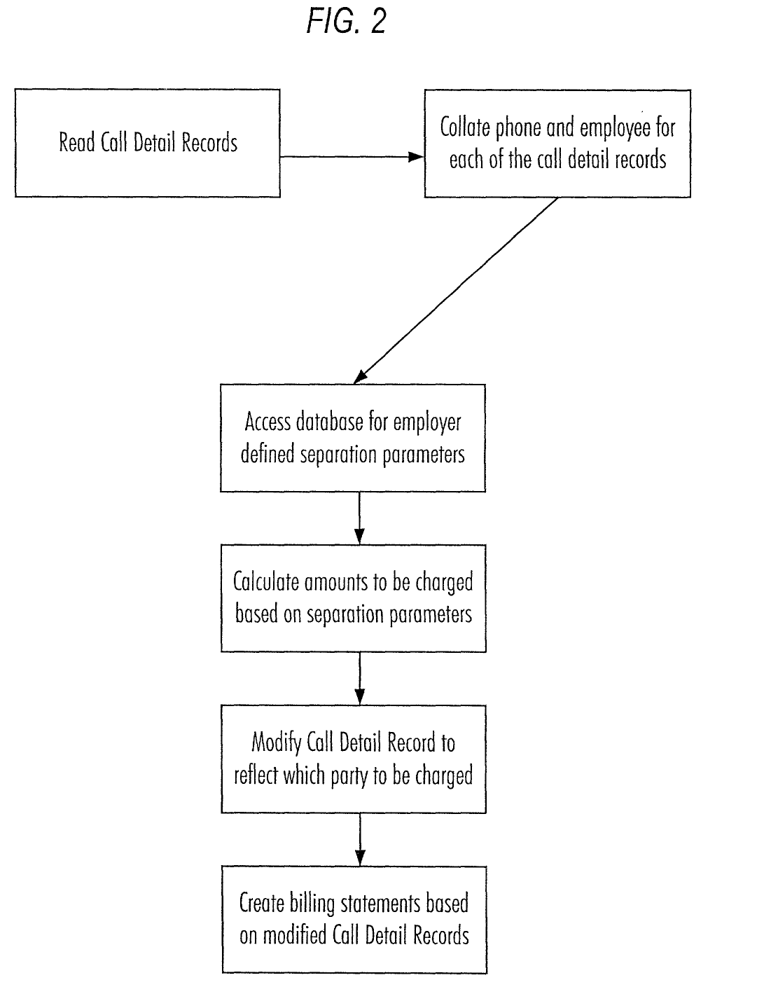

FIG. 3 illustrates a detailed diagram of a separation process employed to generate requested billing delineation.

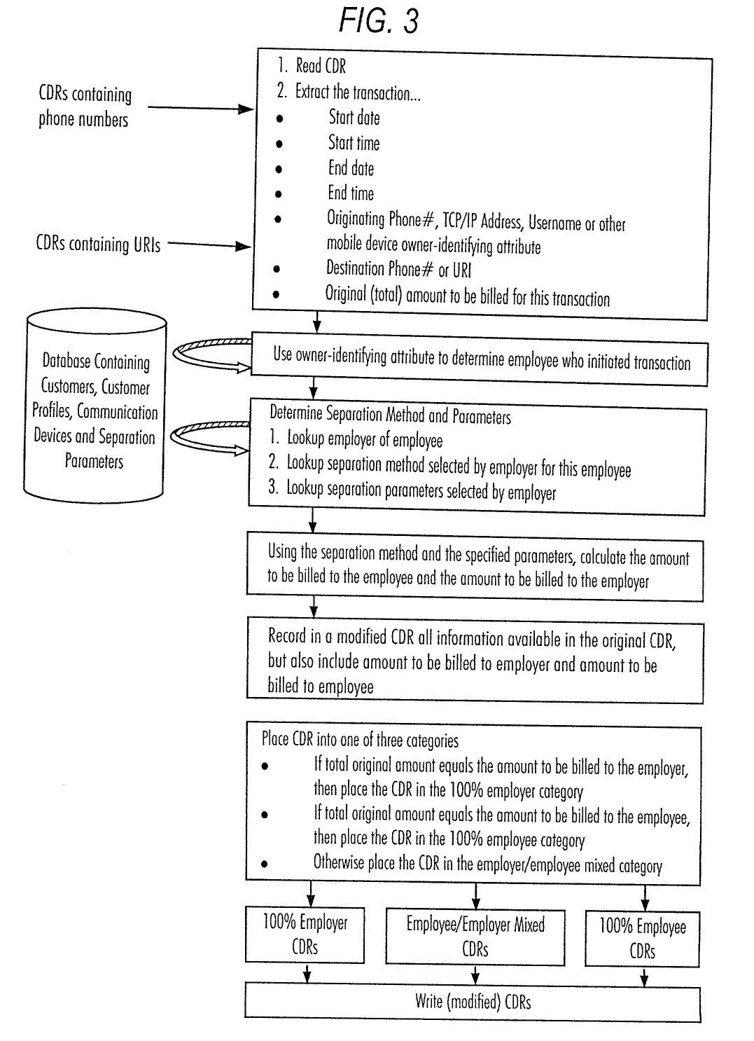

### DETAILED DESCRIPTION OF THE INVENTION

The present invention is generally directed to a method and system for differentiating and/or delineating between calls made on and/or over a mobile telephone, internet and/or other communication system based upon various criteria, including but not limited to, the content of communications made, the time at which such communications were made, whether a particular registered code was entered prior to, during or after such communication, as well as pursuant to any rules specified by a particular employer. For example, an employer may decide that a certain percentage of communications will invariably be those of a personal nature. An employee may decide, for example, to have the employer absorb ten percent (10%) of communications that would otherwise be deemed solely employee communications, thus providing the employee with a type of fringe benefit of the employer. The present invention contemplates a flexible computer program, method and system whereby an employer could periodically make changes to rules designating how, when and why certain charges will be either absorbed by the employer or, alternatively, directed to the employee or outside entity for bill paying responsibilities. In one embodiment of the method of the present invention, the following steps are performed:

1. Call Details Records (“CDRs”) are received from the responsible carrier.

2. Separation Rules which the employer has previously defined are used to evaluate each individual CDR and determine whether the call is a Business (Employer) or Personal (Employee) call. Three types of CDRs are the result: 100% Employer calls, 100% Employee calls and mixed Employee/Employer calls.

3. The billing process consolidates the many CDRs produced by the separation process into a Billing Statement.

In another embodiment of the method of the present invention, the following steps are performed:

1. The separation parameters are defined.

2. CDRs are received from the phone carrier and read by any device which will permit the information to be input into a computer. For example, reading or scanning devices, manual input, conversion devices, or the like.

3. The phone and employee are collated to ensure that the correct employee is billed for the phone calls.

4. The database containing separation parameters is accessed to retrieve the previously-defined separation parameters.

5. Using the separation parameters, the amounts of charges to be billed to the various entities are calculated.

6. The CDRs are modified to reflect which entity will be billed for each particular call.

7. Billing statements based on the modified CDRs are created. The billing statements can be created in any format, including but not limited to hard copies or electronic copies in database, electronic mail, or word processing programs.

The Employer can specify a) the type of separation which should be applied to the CDRS, b) the parameters of said separation method and optionally, c) the manner in which multiple separation methods should be combined. Separation parameters include:

a) Fixed Amount Separation; the employer designates the maximum amount that will be billed to the Employer. Alternatively, the Employer may designate the maximum amount that will be billed to the Employee.

b) Percent Separation; the employer designates what percentage of the total fees will be billed to the employer. The remainder (=100% less the designated percentage) will be the amount that is billed to the employee.

c) Time of Day Separation; the employer designates periods of time (e.g. 8:15 am-5:30 pm) during a given day which are to be considered ‘Business Hours’. Services rendered during designated business hours will be billed to the employer. The remainder of the services will be billed to the employee.

d) Day of Week Separation; the employer will designate days of the week (e.g. Monday through Friday) which are considered to be ‘Working Days’. Services rendered on working days will be billed to the employer. Services rendered on other days will be billed to the employee.

e) Holiday Separation; services rendered on recognized holidays will be billed to the employee. Other services will be billed to the employer.

f) Employer Work Schedule Separation; the employer designates an annual schedule. The employer indicates on said schedule which days shall be deemed Work Days and which days shall be deemed non-work days. Services rendered on work days will be billed to the employer. Other services will be billed to the employee.

g) Keypad Separation; after completing a service transaction (e.g. a voice or data call or browsing to a URI), or before completing said transaction, which is based on the features and capabilities of the mobile device being used, the user enters one or more pre-designated keys (e.g. pressing ‘1’ for personal or ‘2’ for business). These additional keys are recorded by the carrier (=Service provider) and are included in the CDRS. During the separation process calls are identified as employer or employee calls by looking up the entered key and comparing it to what the employer had specified as codes indicating either business or personal transactions.

h) Registered Number Separation; the employer designates a list of pre-defined numbers which are to be considered by the separation process as employer calls; all service transactions initiated to the registered numbers are billed to the employer. Other service transactions are billed to the employee.

i) Wildcard Registered Number Separation; identical to Registered Number Separation except that instead of predefined numbers, the employer designates predefined ‘Wild Cards’ and numbers. An ‘*’ indicates zero or more digits. A ‘?’ indicates any single digit. For example ‘?2345678’ would match ‘12345678’, ‘22345678’, ‘32345678’, ‘42345678’, ‘52345678’, ‘62345678’, ‘72345678’, ‘82345678’, ‘92345678’, ‘02345678’. Also ‘123*’ will match ‘1238’, ‘123848323’, ‘123’ and ‘1230000’, but not ‘124’ nor ‘1278’.

j) Regular Expression Registered Number Separation; identical to Registered Number Separation except that instead of predefined numbers, the employer designates predefined ‘Regular Expressions’. Regular expressions are commonly used within the computer industry and provide for pattern matching. As an example a ‘*’ can be used to indicate zero more repetitions of the preceding character (or in this case digit), a ‘?’ can indicate any single digit, ‘[0-2]’ indicates either 0 or 1 or 2, but no other digit, etc. An employer specified regular expression ‘090 [0-7]*3’ would match all phone numbers beginning with ‘090’, ending with ‘3’ and optionally having any number of digits 0-7 in-between ‘090’ and ‘3’.

k) Registered URI Separation; the Employer designates predefined URIs (Universal Resource Indicators) which will be considered to be employer related. Service transaction to designated URIs will be billed to the employer. Other services transactions will be billed to the employee. For example ‘http://www.abcinc.com/expense_reports.html’ may be designated as an employer URI.

l) Wildcard URI Separation; identical to URI Separation except that the employer designates wildcard patterns rather than fixed URIS. For examples ‘http://www.xyzcompany.cojp/corporate/*’ will designates all URIs which begin with ‘http://www.xyzcompany.cojp/corporate/’.

m) Regular Expression URI Separation; identical to URI Separation except that the employer designates regular expressions rather than fixed URIS.

n) Combination Separation; the employer designates any practical combination of the above separation methods. Practical is defined as a combination which is physically possible and describable. The employer also designates the precedence of the separation methods selected. For example Time of Day Separation can be combined with Percentage Separation as follows: transactions serviced during non-Work Hours are designated by the separation process as employee calls; transactions serviced during Work Hours are divided according to the predefined percentages, such as 60% employer paid and 40% employee paid.

It should be noted that other separation rules can be defined and implemented. The disclosure herein is not meant to be limited to the separation rules defined above and one of ordinary skill in the art could easily determine other separation rules which can be administered and would fall within the scope of the disclosure herein.

This process takes all CDRs which must be combined to form a single employer and a single employee bill (essentially those services transactions which were initiated during the billing period which is covered by the bills), examine each one in turn and places it into one of three categories: 100% employer paid, 100% employee paid and mixed employer/employee paid. For those CDRs which end up in the “mixed” category, additional information is recorded along with the CDR, for example, the amount which is to be billed to the employer and the amount which is to be billed to the employee, etc.

The program of the present invention is written to read the CDRs, access the database containing the separation parameters, calculate the charges based on the previously defined separation parameters, and create billing statements based on the CDRs, separation parameters and calculated charges. The program may be written in any language that will facilitate the performance of these functions.

While various embodiments of the present invention have been described in detail, it will be apparent that further modifications and adaptations of the invention will occur to those skilled in the art. It is to be expressly understood that such modifications and adaptations are within the spirit and scope of the present invention.

What is claimed is:

1. A process for producing separate employee and employer statements of mobile communication device usage based on separating call detail records on a per-record basis into one of at least three categories in accordance with employer determined rules, said categories selected from the group consisting of solely employer-usage, solely employee-usage and mixed employee and employer usage.

2. A system for determining the responsibility for billing charges related to the use of communication devices, comprising:
means for analyzing records received from a communication carrier;
means for implementing separation rules with respect to said records using predetermined methods of distinguishing between solely employer-related communications and solely employee-related communications; and
means for generating a report indicating whether an employer or an employee is responsible for particular communications contained in said report.

3. A system for determining the responsibility of billing charges as claimed in claim 2 wherein the separation rules are selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

4. A system for determining the responsibility of billing charges as claimed in claim 2 wherein said separation rules are any combination of rules selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

5. A system for determining responsibility for billing charges related to the use of communication devices, comprising:
analyzing records received from a communication carrier;
implementing separation rules with respect to said records using predetermined methods of distinguishing between solely employer related communications; and
generating a report indicating whether an employer or an employee is responsible for particular communications contained in said report.

6. A system for determining responsibility for billing charges according to claim wherein the separation rules are selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

7. A system for determining responsibility of billing charges according to claim wherein the separation rules are any combination of rules selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

8. A method of separating bill charges comprising the following steps:
defining separation parameters;
analyzing the charges;
separating the charges based on the defined separation parameters;
calculating the total of the separated charges; and, creating billing statements containing the separated charges.

9. A method of separating bill charges according to claim 8 wherein the separation parameters are selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

10. A method of separating bill charges according to claim 8 wherein the separation parameters are any combination of parameters selected from the group consisting of fixed amount, percentage, time of day, day of week, holiday, employer work schedule, keypad, registered number, wildcard registered umber, regular expression registered number, registered universal resource indicator, wildcard universal resource indicator, and regular expression universal resource indicator.

11. A method of separating bill charges comprising the following steps:
analyzing the charges;
accessing a database containing separation parameters;
separating the charges based on the accessed database;
creating billing statements containing the separated charges.

12. A method of doing business whereby personal communications are charged to employees comprising the following steps:
defining separation rules;
analyzing communication records containing personal communication records and work-related communication records;
separating personal communication records from work-related communication records based on the separation rules; and,
creating statements delineating the personal communication records.
